(19) United States
(12) Patent Application Publication
(10) Pub. No.: US 2011/0210945 A1
(43) Pub. Date: Sep. 1, 2011

(54) PROJECTOR

(75) Inventor: Nobuhiro FUJINAWA, Yokohama-shi (JP)

(73) Assignee: NIKON CORPORATION

(21) Appl. No.: 13/033,310

(22) Filed: Feb. 23, 2011

(30) Foreign Application Priority Data
Feb. 25, 2010 (JP) 2010-040818

(51) Int. Cl. G06F 3/042

(52) U.S. Cl. 345/175

(57) ABSTRACT

Provided are: a projection unit that projects an image displayed on an image formation region of a display unit, and projects an icon displayed on a non-image formation region other than the image formation region, onto a projection surface; an imaging unit that images a region that includes the icon on the projection surface; a detection unit that detects the selection of the region that includes the icon, based on imaging data output from the imaging unit; and a processing unit that, when the selection of the region that includes the icon is detected by the detection unit, performs processing indicated by the icon included in the selected region.

### CROSS-REFERENCE TO RELATED APPLICATIONS

The disclosure of the following priority application is herein incorporated by reference:

Japanese Patent Application No. 2010-40818 filed on Feb. 25, 2010.

### TECHNICAL FIELD

The present invention relates to a projector.

### BACKGROUND ART

Conventionally, there have been input devices for recognizing that a handwriting input surface projected onto a desk and the like is pointed at by a pen, a finger of the operator, and the like, based on an image signal obtained by imaging the handwriting input surface (for example, see Patent Literature 1).

### CITATION LIST

### Patent Literature

Patent Literature 1: Japanese Unexamined Patent Application Publication No. 2008-134793

### SUMMARY OF INVENTION

### Technical Problem

However, since a projected image may overlap the image of the handwriting input surface, the projected image may not be easily viewed. Furthermore, when giving processing instructions by means of the operation controls provided on the unit, the operator is required to extend his or her arm toward the operation controls whenever giving instructions, and thus it is not possible to easily give the instructions.

An object of the present invention is to provide a projector that enables easily giving processing instructions without the use of the operation controls provided on the unit.

### Solution to Problem

A projector of the present invention includes: a projection unit that projects an image displayed on an image formation region of a display unit, and an icon displayed on a non-image formation region other than the image formation region onto a projection surface; an imaging unit that images the regions that include the icon on the projection surface; a detection unit that, based on imaging data output from the imaging unit, detects that a region that includes the icon has been selected; and a processing unit that, when the detection unit has detected that the region that includes the icon has been selected, performs processing indicated by the icon that is included in the selected region.

### ADVANTAGEOUS EFFECTS OF INVENTION

According to the present invention, it is possible to easily give processing instructions without the use of the operation controls provided on the unit.

### BRIEF DESCRIPTION OF DRAWINGS

FIG. 1 is a perspective view illustrating a state in which an image is projected by a projector according to an embodiment.

FIG. 2 is a sectional view illustrating the internal configuration of a projection unit according to the embodiment.

FIG. 3 is a block diagram illustrating the system configuration of a projector according to the embodiment.

FIG. 4 is a table illustrating states in which images are projected depending on whether a trapezoidal correction is performed or not, according to the embodiment.

FIG. 5 is a perspective view illustrating a state in which an image is projected by the projector according to the embodiment.

FIG. 6 is a diagram illustrating a state in which an image is projected by the projector according to the embodiment.

### DESCRIPTION OF EMBODIMENTS

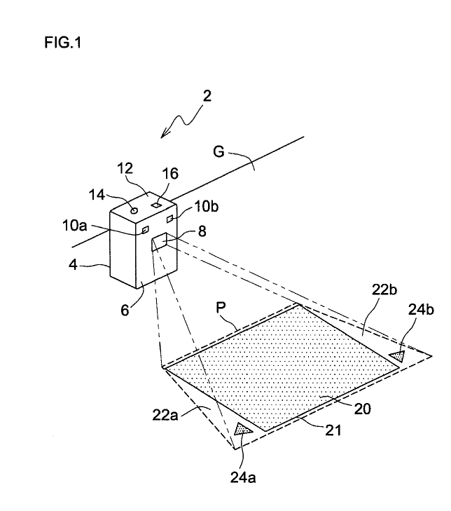

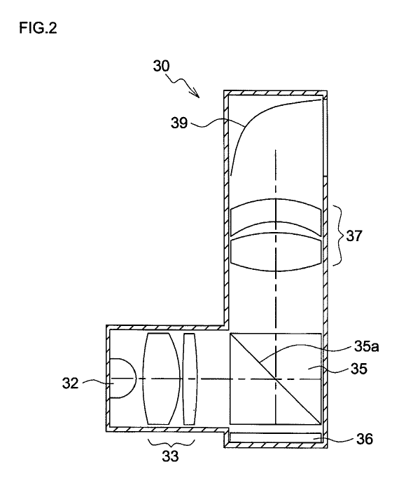

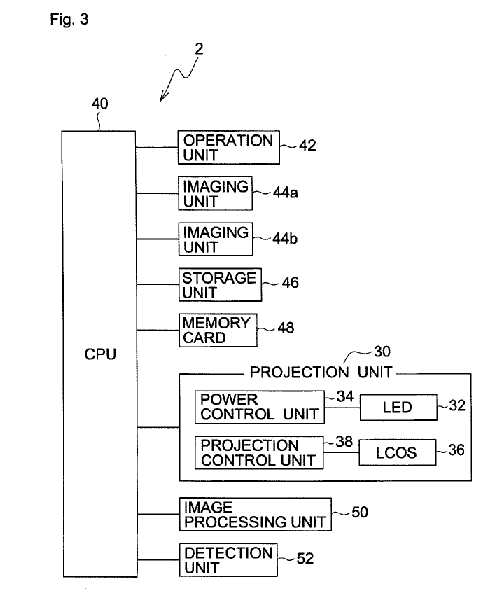

Hereinafter, a projector according to an embodiment of the present invention will be described with reference to the accompanying drawings. FIG. 1 is a perspective view illustrating a state in which an image is projected by the projector according to the embodiment. A projector 2 includes a housing 4 made of a metal or a plastic. A front surface 6 of the housing 4 is provided with a projection window 8, through which projected light from a projection unit 30 (see FIG. 2) contained in the housing 4 is projected, and photographic windows 10a and 10b through which subject light is incident on imaging units 44a and 44b (see FIG. 3) contained in the housing 4. Furthermore, an upper surface 12 of the housing 4 is provided with a power switch 14 and a projection button 16 for projecting an image. In addition, a rear surface of the housing 4 is provided with various input terminals (not shown).

The projector 2 is installed upright such that the lower surface of the housing 4 comes into contact with an installation surface G that is a horizontal surface. Furthermore, since the projection light emitted from the projection unit 30 through the projection window 8 of the housing 4 is projected obliquely downward, the projection light is projected onto a trapezoidal projection region P on the installation surface G.

FIG. 2 is a sectional view illustrating the internal configuration of the projection unit 30 according to the embodiment. In FIG. 2, the right side of the drawing is a front part of the projection unit 30. Light emitted from an LED 32 serving as a light source for emitting the projection light is converted into parallel light by a condenser lens group 33, after which it is made incident on a PBS (polarizing beam splitter) 35, and is then incident on a polarization separating film 35a provided at an angle of 45 degrees with respect to a travel direction of the incident light. Only S-polarized light of the light incident on the polarization separating film 35a is reflected by the polarization separating film 35a, and is then incident into an LCOS 36 serving as an image display section. Meanwhile, P-polarized light that has passed through the polarization separating film 35a is absorbed by the PBS 35.

The light incident on the LCOS 36 is reflected by the LCOS 36 and is once again incident on the PBS 35. Here, when a voltage is applied to a liquid crystal layer (not shown) configuring the LCOS 36, the liquid crystal layer serves as a phase plate. Thus, of the light emitted from the LCOS 36, the light which has passed through a pixel region to which the voltage is applied by the liquid crystal layer is converted from S-polarized light to P-polarized light. Meanwhile, of the light emitted from the LCOS 36, the light which has passed through a pixel region to which the voltage is not applied by the liquid crystal layer travels onward as S-polarized light.

Of the light that is emitted from the LCOS 36 and is once again incident on the PBS 35, only the P-polarized light, which has passed through the voltage-applied pixel region of the LCOS 36, passes through the polarization separating film 35a and is separated from the S-polarized light. The P-polarized light is emitted from the projection window 8 through a projection lens group 37 for projecting an image and a mirror 39 having a free curved surface for deflecting the projection direction of light emitted from the projection lens group 37 into the direction of the installation surface G, and is projected onto the projection region P on the installation surface G. Here, the projector 2 according to the present embodiment performs trapezoidal correction processing on the projected image by means of the mirror 39 having the free curved surface and which is in the projection unit 30, and image processing performed by an image processing unit 50, so as to project a rectangular image 20 onto an image projection region 21 of the projection region P. In this way, both the trapezoidal correction processing by the mirror 39 having the free curved surface and the trapezoidal correction processing by the image processing unit 50 are performed, so that an optical system can be easily designed and manufactured, resulting in a reduction of cost. In addition, the projection unit 30 is a free curved surface optical system provided with the mirror 39 having a free curved surface; however, the position at which the free curved surface is arranged is not limited to the mirror 39.

FIG. 3 is a block diagram illustrating the system configuration of the projector 2 according to the embodiment. The projector 2 includes a CPU 40 to which are connected an operation unit 42 that includes the power switch 14 and the projection button 16 for projecting an image; the imaging units 44a and 44b that image subject light; and a storage unit 46 that stores image data generated as a result of an A/D conversion unit (not shown) performing A/D conversion on imaging signals output from the imaging units 44a and 44b. Furthermore, a memory card 48 that stores image data such as a still image and a moving image, and a projection unit 30 that projects an image based on the image data, are also connected to the CPU 40. Furthermore, an image processing unit 50 that performs image processing, such as trapezoidal correction processing, rotation processing, and enlargement and reduction processing, on the image that is based on the projected image data, and a detection unit 52 that detects, based on the imaging data output from the imaging units 44a and 44b, that regions including icons 24a and 24b are selected, are connected. Here, the projection unit 30 includes a power control unit 34 for lighting up and turning off the LED 32 serving as a light source, and a projection control unit 38 for performing display control of the LCOS 36 that displays the projected image.

Next, projection processing in the projector 2 according to the embodiment will be described. In the projector 2 illustrated in FIG. 1, if the power switch 14 is pressed by an operator and the projection button 16 is further pressed by the operator, then the CPU 40 projects the rectangular image 20 onto the image projection region 21 of the projection region P on the installation surface G, based on the image data of the still image stored in the memory card 48, and at the same time, projects the icons 24a and 24b onto triangular icon projection regions 22a and 22b positioned at both sides of the projection region P.

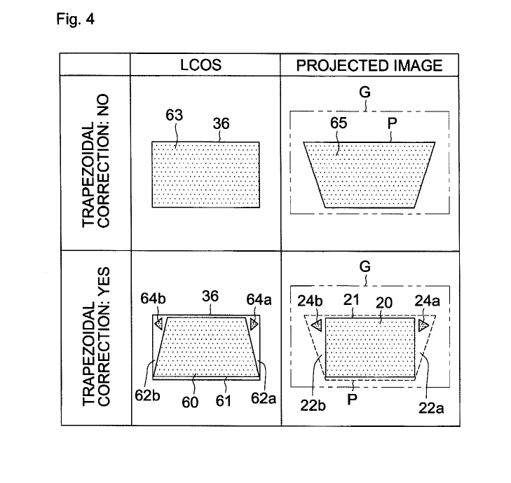

Herein, the trapezoidal correction processing by the image processing unit 50 will be described with reference to FIG. 4 below. FIG. 4 is a diagram illustrating a state in which images are displayed in the LCOS 36 depending on whether trapezoidal correction processing is performed or not, and a state of an image projected onto the projection region P. In the case of “trapezoidal correction: NO” in which trapezoidal correction processing is not performed, an image 63 based on image data upon which trapezoidal correction processing has not been performed is displayed on the entire surface of the LCOS 36. In this case, the image 63 displayed on the LCOS 36 is projected onto the projection region P on the installation surface G. That is, a trapezoidal image 65 is projected onto the entire surface of the projection region P.

Meanwhile, in the case of “trapezoidal correction: YES” in which trapezoidal correction processing is performed, a trapezoidal image 60 based upon the image data upon which trapezoidal correction processing has been performed by the image processing unit 50 is displayed on an image formation region 61 of the LCOS 36. In this case, triangle-shaped non-image formation regions 62a and 62b positioned at both sides of the LCOS 36 are not used to display the image 60. Thus, icons 64a and 64b are displayed on the non-image formation regions 62a and 62b. Consequently, the image 60 and the icons 64a and 64b displayed on the LCOS 36 are projected onto the projection region P on the installation surface G. That is, the rectangular image 20 is projected onto the image projection region 21 of the projection region P and the icons 24a and 24b are projected onto the icon projection regions 22a and 22b. It is noted that the icon projection regions 22a and 22b of the projection region P are regions for which the accuracy of optical design is difficult to ensure. However, no problems occur even if processing such as exact aberration correction is not performed on the icons 24a and 24b.

The CPU 40 images regions including the icons 24a and 24b of the projection region P at predetermined time intervals according to the imaging units 44a and 44b, respectively. Next, based on the imaging data output from the imaging units 44a and 44b, the CPU 40 detects the selection of regions including the icons 24a and 24b, by means of the detection unit 52. That is, when a finger of the operator makes contact with the icon projection regions 22a and 22b that include the icons 24a and 24b, the CPU 40 detects the selection of the regions that include the icons 24a and 24b, by means of the detection unit 52. Then, the CPU 40 performs processing indicated by the icons 24a and 24b that are included in the selected regions. For example, when the icon 24a has been preset as a “right feed mark” indicating the feeding of one still image, if a finger of the operator makes contact with the icon projection region 22a, then the CPU 40 projects a subsequent image 20. Furthermore, when the icon 24b has been preset as a “left feed mark” indicating the feeding of one still image in an opposite direction, if the finger of the operator makes contact with the icon projection region 22b, then the CPU 40 projects a prior image 20.

In accordance with the projector according to the embodiment of the present invention, it is possible to easily give processing instructions without the use of the operation controls provided on the unit. Furthermore, an intuitive operation by the operator is possible.

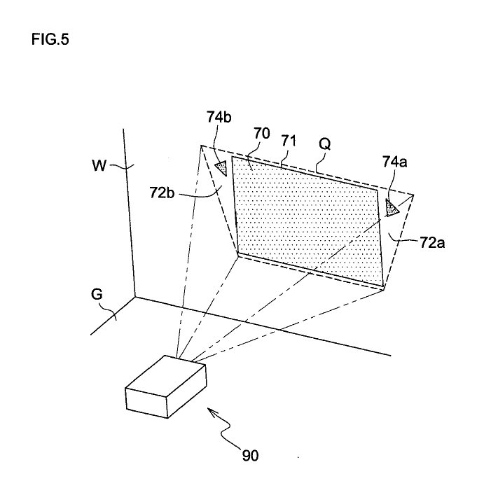

In addition, in the above-described embodiment, the projection unit 30 uses the free curved surface optical system provided with the mirror 39 having a free curved surface. However, an optical system having no free curved surface may be used. FIG. 5 is a diagram illustrating a state in which projection light from the projection unit 30 of a projector 90 using an optical system having no free curved surface is projected onto a wall surface W approximately perpendicular to the installation surface G. Since the system configuration of the projector 90 is identical to that illustrated in FIG. 3, the structural elements of the projector 90 identical to those of the projector 2 are denoted with the same reference numerals.

As illustrated in FIG. 5, the projector 90 projects a rectangular image 70 onto a projection region Q on the wall surface W and projects icons 74a and 74b onto triangular icon projection regions 72a and 72b, which are positioned at both sides of the projection region Q, respectively. That is, the trapezoidal correction processing is performed on an image projected only by the image processing unit 50, so that the rectangular image 70 is projected onto an image projection region 71 of the projection region Q and the icons 74a and 74b are projected onto the icon projection regions 72a and 72b of the projection region Q.

Next, in the same manner as the above-described embodiment, the selection of regions that include the icons 74a and 74b is detected by means of the detection unit 50, based on the imaging data output from the imaging units 44a and 44b. For example, when the icons 74a and 74b have been preset as a “right feed mark” and a “left feed mark”, respectively, if a finger of the operator makes contact with the icon projection regions 72a and 72b, then processing indicated by the icons 74a and 74b are performed. Even in such a case, in the same manner as the above-described embodiment, the icons 74a and 74b are projected together with the rectangular image 70, and the selection of the icon projection regions 72a and 72b is detected, so that it is possible to easily give processing instructions without the use of the operation controls provided on the unit.

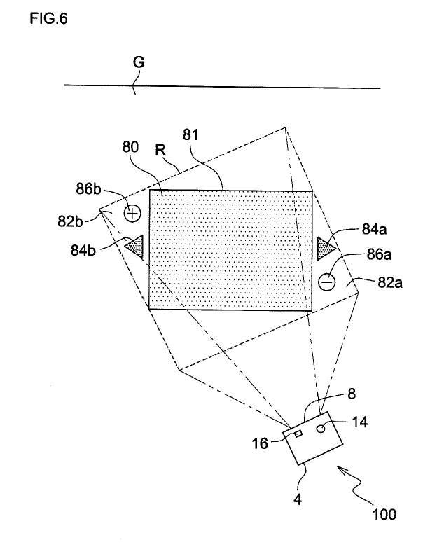

Furthermore, FIG. 6 is a diagram illustrating the state in which projection light from the projection unit 30 of a projector 100 including a free curved surface optical system is projected onto the installation surface G. In addition, as illustrated in

FIG. 6, in the projector 100, a rectangular projection region R is formed on the installation surface G by means of the free curved surface optical system of the projection unit 30. Furthermore, a rectangular image 80 projected onto the projection region R is rotated at a predetermined angle by means of the free curved surface optical system of the projection unit 30 and the image processing by the image processing unit 50. That is, an image projection region 81 of the projection region R is rotated at the predetermined angle, and the rectangular image 80 is projected. Furthermore, the image 80 is rotated at the predetermined angle, and as a result, icons 84a and 84b and icons 86a and 86b are projected onto icon projection regions 82a and 82b onto which the image 80 is not projected, respectively.

Even in such a case, in the same manner as the above-described embodiment, the selection of regions that include the icons 84a and 84b or the icons 86a and 86b is detected by means of the detection unit 50, based on the imaging data output from the imaging units 44a and 44b. For example, when the icons 84a and 84b have been preset as a “right feed mark” and a “left feed mark” and the icons 86a and 86b have been preset as “reduction” for reducing the image 80 and “enlargement” for enlarging the image 80, respectively, then if a finger of the operator makes contact with a region near the icon 84a of the icon projection region 82a, then a subsequent image 80 is projected, and if a finger of the operator makes contact with a region near the icon 86a of the icon projection region 82a, then an image 80 reduced through reduction processing is projected. Meanwhile, if a finger of the operator makes contact with a region near the icon 84b of the icon projection region 82b, then a prior image 80 is projected, and if a finger of the operator makes contact with a region near the icon 86b of the icon projection region 82b, then an image 80 enlarged through enlargement processing is projected.

In this case, the icons 86a and 86b may be projected onto triangular regions positioned above and below, respectively, of the image 80 in the projection region R, onto which the image 80 is not projected. For example, if a finger of the operator makes contact with the triangular region above the image 80 of the projection region R, then the reduced image 80 is projected. Meanwhile, if a finger of the operator makes contact with the triangular region below the image 80 of the projection region R, then the enlarged image 80 is projected. In this case, regions imaged by the imaging units 44a and 44b are enlarged, and the icon projection regions above and below the image 80 of the projection region R and regions that include the icon projection regions 82a and 82b, are imaged by the imaging units 44a and 44b.

Furthermore, a magnet or a suction cup may be provided to the lower surface of the housing 4. Consequently, it is possible to install a projector on a vertical surface such as a wall surface W or a white board.

Furthermore, in the above-described embodiment, when a finger of the operator makes contact with the icon projection regions 22a and 22b, the processing indicated by-the icons 24a and 24b are performed. However, when the icon projection regions 22a and 22b are irradiated with laser light from a laser pointer or the front end of a pointer rod makes contact with the icon projection regions 22a and 22b, the processing indicated by the icons 24a and 24b may be performed. Consequently, even if the operator moves away from the projection region, it is possible to easily give processing instructions by means of a laser pointer or a pointer rod.

Furthermore, in the above-described embodiment, the image based on the image data of the still image stored in the memory card 48 is projected. However, an image based on image data of a moving image stored in the memory card 48 may be projected. Furthermore, when projecting the image based on the image data of the moving image, the processing indicated by the icons 24a and 24b may be changed to a “reproduction button” for reproducing the moving image and a “stop button” for stopping the reproduction of the moving image, respectively. In this case, while if a finger of the operator makes contact with the icon projection region 22a, then the moving image is reproduced, and if a finger of the operator makes contact with the icon projection region 22b, then the reproduction of the moving image is stopped.

In addition, in the above-described embodiment, the processing indicated by the icons 24a and 24b have been preset as the “right feed mark” and the “left feed mark”, respectively. However, the processing indicated by the icons 24a and 24b may be preset as a “start button” for starting a slide show and a “cancel button” for cancelling the slide show, respectively. In such a case, while if a finger of the operator makes contact with the icon projection region 22a, then the slide show is started for the image based on the image data of the still image stored in the memory card 48, and if a finger of the operator makes contact with the icon projection region 22b, then the slide show is canceled.

Moreover, in the above-described embodiment, the processing indicated by the icons 24a and 24b have been preset as the “right feed mark” and the “left feed mark”, respectively. However, the processing indicated by the icons 24a and 24b may be preset as a “thumbnail display button” for performing a thumbnail display and a “thumbnail cancel button” for cancelling the thumbnail display, respectively. In this case, if a finger of the operator makes contact with the icon projection region 22a, then the thumbnail display is performed for the image based on the image data of the still image stored in the memory card 48, and if a finger of the operator makes contact with the icon projection region 22b, then the thumbnail display is canceled.

The embodiments explained above have been described so that the present invention is understood more easily, and are not intended to limit the present invention. Therefore, the elements disclosed in the embodiments described above are intended to include all modifications of design and equivalents belonging to the technical scope of the present invention.

1. A projector comprising:
a projection unit that projects an image displayed on an image formation region of a display unit, and projects an icon displayed on a non-image formation region other than the image formation region, onto a projection surface;
an imaging unit that images a region that includes the icon on the projection surface;
a detection unit that detects the selection of the region that includes the icon, based on imaging data output from the imaging unit; and
a processing unit that, when the selection of the region that includes the icon is detected by the detection unit, performs processing indicated by the icon included in the selected region.

2. The projector according to claim 1, wherein the non-image formation region is a region in which the image is not displayed as a result of a trapezoidal correction having been performed on the image.

3. The projector according to claim 1, wherein the non-image formation region is a region in which the image is not displayed as a result of the image having been rotated at a predetermined angle.

4. The projector according to claim 1, wherein the projection unit includes a free curved surface optical system.
